(19) United States
(12) Patent Application Publication
(10) Pub. No.: US 2009/0300547 A1
(43) Pub. Date: Dec. 3, 2009

(54) RECOMMENDER SYSTEM FOR ON-LINE ARTICLES AND DOCUMENTS

(75) Inventors: Keith M. Bates, Toronto (CA); Julian Paas, Mississauga (CA); Biao Wang, Toronto (CA); Bo Xu, Toronto (CA); Pendar Yousefi, Toronto (CA)

Correspondence Address: VENABLE LLP, P.O. BOX 34385, WASHINGTON, DC, 20043-9998, US

(73) Assignee: Kibboko, Inc., Toronto (CA)

(21) Appl. No.: 12/360,516

(22) Filed: Jan. 27, 2009

(30) Foreign Application Priority Data
May 30, 2008 (CA) 2,634,020

(51) Int. Cl. G06F 17/30; G06F 3/048

(52) U.S. Cl. 715/825; 707/5; 706/47; 707/E17.014

(57) ABSTRACT

A system and method for recommending on-line articles and documents to users is disclosed. The method provides an article widget user interface and a full-screen widget user interfaces to allow a user to rate articles, to preview articles, to filter articles based on category, article length, or other characteristics. A recommender system is configured to provide a continually refreshing list of recommended articles to the user via the user interfaces. The system comprises a module configured to monitor the user's explicit and implicit interactions with the user interfaces, and provides a refreshed list of recommended articles accordingly. The recommender system may be configured to use a package of approaches including rule-based, content-based or collaborative filtering approaches including Slope, Co-Visitation, Mwinnow and Clustering/Co-clustering.

### RELATIONSHIP TO OTHER APPLICATIONS

This application claims priority from and incorporates by reference the subject matter of the application entitled SYSTEM AND METHOD FOR MULTI-LEVEL ONLINE LEARNING filed with the C.I.P.O. on May 30, 2008 and assigned U.S. Pat. No. 2,634,020.

### FIELD OF THE INVENTION

This invention relates to a computer-implemented system and method for interacting with users, and more specifically, for recommending on-line articles and documents to users.

### BACKGROUND OF THE INVENTION

Proliferation of On-Line Content. The internet is the source of extensive content. The amount and diversity of content is quickly growing. Some estimates suggest that more than 60 billion pages of content are now available on-line, and the amount of content grows continuously. It is a challenge for internet users to separate the relevant from the irrelevant. Increasingly, finding appropriate and desired on-line content is like finding a needle in a haystack, particularly when the article or document desired to be found is not known in advance. If a person has to rely on finding or locating articles or documents known to them in advance, they may miss out on accessing useful, relevant and valuable articles and documents.

Proliferation of On-Line Newspapers, Magazines, Information Portal and Other Information Sources. It is becoming quite common for metropolitan and national newspapers and magazines to have an on-line, or internet version. Readership of such on-line versions is large and growing. For example, between January and October 2008, online newspapers enjoyed an average of 67 million unique visitors per month, logging an average of 3.2 billion page views per month (source Newspaper Association of America & Nielsen Online: http://www.naa.org/TrendsandNumbers/Newspaper-Websites.aspx). As well such online versions have extensive content of all kinds, and typically provide access to archival or past content of such Newspapers and Magazines. In addition to the online versions of newspapers and magazines, there are also online versions of major news cable outlets (CNN and MSNBC and Fox) and large information portals (such as Yahoo, Reuters, Bloomberg and others) as well as general information sites and blogs that provide short essays on various topics (such as About.com and Suite101.com and blogs generally). Although such content may be of interest to users, they may not want to spend their time searching for it. As well, searches may return irrelevant, excessive results. One approach to this proliferation of content of On-Line Newspapers and Magazines is to use some type of recommender system to suggest to the reader new articles and documents that they might be interested in. A recommender system generates ratings or some other indication of relevance or interest for articles or documents that have not yet been seen by the user.

Weaknesses of Current Recommender Systems for On-Line Newspapers and Magazines. Current recommendation systems for on-line newspapers and magazines have a number of disadvantages and present a number of problems:

(a) Current Recommender Systems don't focus on the User Interface. There has been relatively little work carried out on understanding what type of user interface and user experience will best contribute to use and efficiency of a recommendation engine. The prior art has shown little interest in the type of interface or the properties of the users interaction with the recommender system. This is a significant problem since the user interface forms an important aspect of the effectiveness and user acceptance of a recommender system.

(b) Current Recommender Systems do not relate ratings to recommendations in a visible and real-time (or near-real-time) way. Currently available systems do little to promote engagement by the user. Typically the user is asked to provide his or her ratings for an article or other content, but there is no immediate connection between those ratings and the resulting recommendations. Also, users typically have no other choices to specify the kinds of content that they wish to have recommended; while this kind of specification is common in search engines, it is absent in recommendation systems, certainly on large information portals and news sites. The user doesn't have fun in interacting with the system and receiving recommendations from it. As well, the user often has only a limited understanding about why particular recommendations are being made. Because the user cannot see how his or her choices and ratings immediately influence the recommendation or selection of articles, the user may have reduced acceptance of, and confidence in, the Recommender System. As well, many current systems are relatively impersonal—they simply tell a visitor that “people who read this article also read ______”, or “people who read this article bought ______”. They do not appear to be personalized to a great extent.

(c) It is a challenge to manage User Input. Users do not want to spend a lot of time interacting with the recommender system. Some recommender systems solve this problem by not having any explicit entry of information, such as ratings, by an individual user. Such systems may recommend only the most frequently viewed, emailed or commented upon articles. This type of system does not personalize or customize recommendations for a user—a significant disadvantage. At the same time, many Users will not enter ratings or preferences. Another approach to this problem is that some recommender systems collect data about user preferences implicitly. Such information might include pages visited, time spent on the page, whether the page was printed or shared by email. Although it may be less obtrusive to obtain information this way, such information may be quite unreliable or inaccurate as a basis for making recommendations.

(d) New User Problem. Many recommender systems operate, at least in part, by determining that a user is similar to one or more other users, and may be interested in the same things, and then proceeds to recommend to them articles or documents the similar user read or rated highly. Recommender systems are challenged by new users, since there is no or a limited basis to understand how a new user might be similar to existing users. This problem is heightened when a new recommender system is introduced or implemented, since all or many of the users may be fairly characterized as new users. Some systems collect demographic data on users, such as their occupation, age or income, but users may be reluctant to spend the time to provide extensive amounts of such information. These problems are compounded for idiosyncratic users or users with unusual or unique tastes or interests. For such users, there may not be any (or there may be relatively few, users with similar tastes and interests, and as such, it can be difficult to provide them with effective recommendations.

(e) New Article Problem. Many current recommender systems involve some type of rating of an item (e.g. an article or document), correlate this rating with other user attributes or behaviours, and use such ratings and correlations as at least part of a basis to make recommendations. This leads to a problem when new articles are introduced to the recommender system, namely, that the new articles have not been rated and so that there is no basis upon which to recommend such a new article to other users.

(f) Cold Start Problem. The Recommender System may initially have a limited number of users and ratings. In order for users to receive good recommendations, the Recommender System needs to have substantial input of information upon which it will determine similarity between users, articles to be recommended, or other information on which similarity will be determined. When the Recommender System is initially started to be used, there is a limited amount of such information because of the limited number of users and user preferences.

(g) Lack of Diversity Many current Recommender Systems do not recommend complementary and related products or services, or a diverse mix of articles and other media.

(h) Sparsely Rated Content. Where the number of articles and users are increasing quickly, then there may be relatively few articles rated, and relatively few users providing ratings for any particular article. It can be challenging to provide effective and reliable recommendations for such sparsely rated content.

It is a goal of the present invention to address one or more the above-noted disadvantages and weaknesses of current recommender systems.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

The present invention is directed to a computer-implemented system and method interacting with users, and more specifically, for recommending on-line articles and complementary products and services to users.

The present invention may provide one or more of the following benefits or advantages: it may allow the user to see how his or her choices and ratings immediately influence the recommendation or selection of articles; it may increase user engagement; it may increase the number of happy surprises the user experiences, in other words, situations where an item is recommended to the user and he or she is pleased to have received this recommendation; it may increase the number of pages that a user views; it may increase the time that a user spends on a publisher's site; it may increase the frequency and number of the user's visits to a site; and, it may attract more unique visitors to a publisher's site.

An embodiment of the invention provides a system which is the combination of recommendation with a concurrent user interface, with the user interface being adjustable by the user through the manipulation of on-line controls. An important aspect of the present invention is that the user's actions through the user interface may visibly affect the recommendations which are presented. Another important aspect of the present invention is that it permits the operation of the recommender system to be more visibly personalized for each user. Another important aspect of the present invention is that it facilitates faster and more accurate learning about a user's preferences in a way that is not obtrusive.

A computer-implemented method of providing recommendations for articles is provided comprising the steps of providing a user with an initial list of articles by displaying the initial list on a computer display device, receiving input from the user by receiving or monitoring input from at least one input device, said input comprising one or more of: i) an explicit rating for one of said initial list of articles; ii) user data in relation to the user; and iii) an indication the user has changed or set a filter; generating in a microprocessor at least one new recommended article from a list of possible articles, based on the input received from the user; refreshing the initial list of articles with said at least one new recommended article to produce a refreshed list; and providing the user with the refreshed list by displaying the refreshed on the computer display device.

Furthermore, a computer-implemented method of recommending articles is provided comprising the steps of: storing a set of possible articles in a database; receiving information from, or relation to, a first user by receiving or monitoring input from at least one input device, said information including at least one of: i) demographic data about the first user; ii) rating data about one of the set of possible articles from the first user; iii) user data in relation to the first user; iv) transaction data in relation to the first user; and v) information relating to content of an article of interest to the first user; determining in a microprocessor a similarity between the received information and at least one of: i) demographic data about a second user; ii) rating data about one of the set of possible articles from the second user; iii) user data in relation to the second user; iv) transaction data in relation to the second user; v) information relating to content of an article of interest to the second user; and recommending to the first user information about a second article from the set of possible articles based on the determined similarity by displaying the information about the second article on a computer display device, where the recommendation is generated by MWinnow.

In another aspect of the invention, a computer program product is provided comprising: a memory having computer readable code embodied therein, for execution by a CPU for recommending documents, said code comprising: code means for providing a user with an initial list of articles by displaying the initial list on a computer display device; code means for receiving input from the user by receiving or monitoring input from at least one input device, said input comprising one or more of: i) an explicit rating for one of said initial list of articles; ii) user data in relation to the user; iii) an indication user has changed or set a filter; code means for generating at least one new recommended article from a list of possible articles, based on the input received from the user; code means for refreshing the initial list of articles with said at least one new recommended article to produce a refreshed list; and code means for providing the user with the refreshed list.

Furthermore, a computer program product is provided comprising: a memory having computer readable code embodied therein, for execution by a CPU for recommending articles, said code comprising: code means for storing a set of possible articles in a database; code means for receiving information from, or relation to, a first user by receiving or monitoring input from at least one input device, said information including at least one of: i) demographic data about the first user; ii) rating data about one of the set of possible articles from the first user; iii) user data in relation to the first user; iv) transaction data in relation to the first user; and v) information relating to content of an article of interest to the first user; code means for determining in a microprocessor a similarity between the received information and at least one of: i) demographic data about a second user; ii) rating data about one of the set of possible articles from the second user; iii) user data in relation to the second user; iv) transaction data in relation to the second user; v) information relating to content of an article of interest to the second user; code means for recommending to the first user information about a second article from the set of possible articles based on the determined similarity by displaying the information about the second article on a computer display device, where the recommendation is generated by MWinnow.

Moreover, a computer system is provided comprising the following elements: an interface for receiving input from a user by monitoring or receiving input from at least one input device, said input comprising one or more of: i) an explicit rating for one of an initial list of articles presented to the user; ii) user data in relation to the user; iii) an indication the user has changed or set a filter; a user data collection module, for collecting the input from the user and for transmitting information to the user regarding articles; a database, for storing the input, a list of possible article ratings table, and article and user table; a recommender module, for recommending to the user information about one of the list of possible documents, said recommendation based on said input.

### LIST OF FIGURES

FIG. 1A shows an exemplary screenshot of an article widget user interface within a browser window, according to an aspect of the present invention.

FIG. 1B shows the article widget user interface of FIG. 1A, expanded to show article box detail.

FIG. 2 shows an exemplary screenshot of a full-screen widget user interface within a browser window, according to an aspect of the present invention.

FIG. 3 is a block diagram showing the basic structure for the system and method according to an aspect of the present invention.

FIG. 4 is a block diagram showing the steps of a method providing a recommender system according to an aspect of the present invention.

FIG. 5 shows a basic computing system on which the invention can be practiced.

FIG. 6 shows the internal structure of the computing system of FIG. 5.

FIG. 7 is a diagram of the Mwinnow algorithm, for use with the method and system according to an aspect of the present invention.

FIG. 8 is a schematic block diagram illustrating the design architecture of the MWinnow algorithm, for use with the method and system according to an aspect of the present invention.

FIG. 9 is a schematic block diagram illustrating a prototype recommender system based on a pure Mwinnow scheme, for use with the system and method according to an aspect of the present invention.

### DETAILED DESCRIPTION

As used in this application, the terms “approach”, “module”, “component,” “model,” “system,” and the like are intended to refer to a computer-related entity, either hardware, a combination of hardware and software, software, or software in execution. For example, a module may be, but is not limited to being, a process running on a processor, a processor, an object, an executable, a thread of execution, a program, and/or a computer. By way of illustration, both an application running on a server and the server can be a module. One or more modules may reside within a process and/or thread of execution and a module may be localized on one computer and/or distributed between two or more computers. Also, these modules can execute from various computer readable media having various data structures stored thereon. The modules may communicate via local and/or remote processes such as in accordance with a signal having one or more data packets (e.g., data from one module interacting with another module in a local system, distributed system, and/or across a network such as the Internet with other systems via the signal).

The present invention is directed to a computer-implemented system and method interacting with users, and more specifically, for recommending on-line articles and documents to users. In this description, the words article, item and document are used synonymously. In this description, the word article includes advertisements, and may also include other types or categories of media, such as videos, audio files, images and podcasts. The word article also includes products or services which could be provided or purchased.

The system and method for recommending on-line articles or documents is suited for any computation environment. It may run in the background of a general purpose computer. In one aspect, it has CLI (command line interface), however, it could also be implemented with a GUI (graphical user interface) or together with the operation of a web browser.

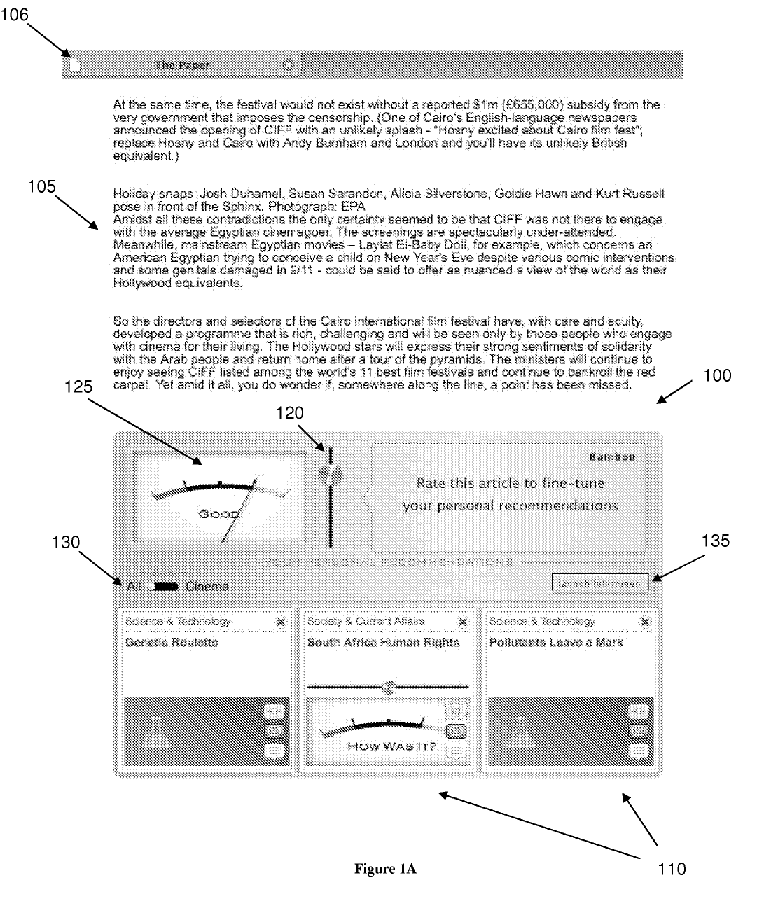

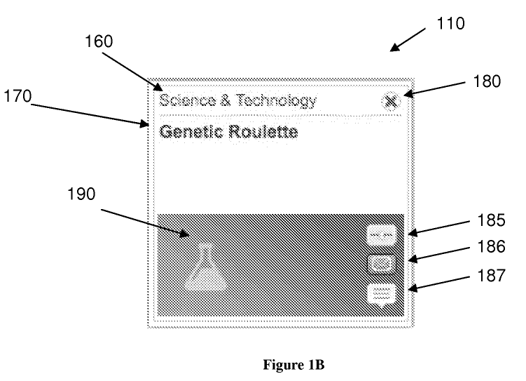

Referring to FIG. 1A, an exemplary screenshot of an article widget user interface 100, according to an aspect of the present invention, is illustrated. Preferably, the article widget user interface 100 is configured to appear when a user has visited an article page (a page which contains the full-text or partial text of a unique text article). The article widget user interface 100 offers two main features: it allows the user to rate the article page; and it recommends other articles to the user. The article widget user interface 100 (sometimes referred to as an article rating screen) may be placed or located at the bottom of article page being viewed in a web browser. Alternatively, the article widget user interface 100 may be placed anywhere on the article page being viewed. This facilitates easy review of articles without having to interrupt ordinary reading or use of the on-line newspaper or magazine in a browser window. For example, FIG. 1A shows the article widget user interface 100 embedded below the full-text of an article 105 within a browser window 106.

Optionally, the system and method of an aspect of the present invention may allow for the previewing and recommendation of more than just text articles, especially given that many news sites are often including large amounts of multimedia content online. With no change in the recommender system or only modest changes in the article widget user interface 100, the system may be configured to show and recommend items including but not limited to text articles, documents, videos, movies, podcasts, audio clips, PDF documents, eBooks or slide presentations, among others. As will be apparent, the meaning of some controls, which will be described later, varies as the type of item varies. For example, if the item was a video or an audio clip, then the control dealing with the length of the item no longer deals with word count, but instead, deals with the duration or playing time of the item. In some cases, just a preview of the recommended article is shown. In another embodiment of the present invention, the system is configured to allow the user to filter out recommendations based on media type: “show video only”, “show PDFs only”. As such, use of the term “article” could encompass any media object including text articles, documents, videos, movies, podcasts, audio clips, PDF documents, eBooks or slide presentations, among others.

Still with reference to FIG. 1A, the user's rating is collected through the use of a rating slider 120 (e.g. a 5-level slider) or other user interface instrument. An optional rating-meter panel 125 (“dash board gauge”) displays the current rating and serves as the user's visual confirmation of his or her rating.

Moreover, with reference to FIG. 1A, a small list of recommended articles are presented as a set of article boxes 110 (three such article boxes 110 are shown in FIG. 1A). With reference to FIG. 1B, each article box 110 may contain the category label 160, the article title 170, a dismiss button 180, and the article image 190. Furthermore, hovering over the article may open a tooltip that displays a few lines from the article (not shown). The article image 190 would typically be the only, main or largest image associated with the article. In an alternative embodiment, the dismiss button 180 may be extended to include options such as “don't want to read”, “don't show me articles like this one”, or “I already know about this article”, and so on. When the dismiss button 180 is clicked, the associated article box 110 is replaced with an article box 110 for the next highest ranked article (or a random new article conforming to the filters, described below). The article box 110 may also have a preview button 187, which, when clicked, shows a portion of text from the article, and an email button 186. The article box 110 may also have a rate button 185 which, when clicked, shows a rating slider for that article. The user can then use the slider to rate that article. There may also be a shuffle button (not shown) which, when clicked, replaces all the article boxes 110 with, for example, article boxes 110 for the next highest ranked articles.

Where a user dismisses an article it will, in a preferred embodiment, be automatically given the lowest possible rating. In a further embodiment, articles found by recommendation module 320 to have similar content or to reflect a similar user preference to the dismissed article, are less likely to be presented or recommended to the user or presented or recommended to the user for a period of time.

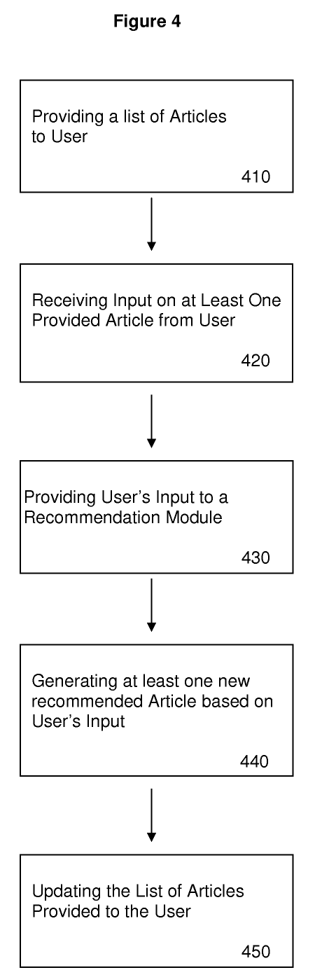

Still with reference to FIG. 1A, the user interacts with the article widget user interface 100 by rating and viewing recommended articles (articles that are promoted by the recommender engine as being recommended). The article widget user interface 100 is configured such that rating the article page will refresh the list of recommended articles that is presented to the user. This refreshing is carried out dynamically, and is as close to real-time as system and network performance will permit. A recommendation module 320, either directly or through the use of intermediate modules, monitors the user's rating or other information regarding the user or his or her activity or preferences, and generates, as is described in more detail below, a list of recommended articles based on the rating or other information. As the user modifies his or her rating of the article page through the use of the rating slider 120, the list is “refreshed” or changed, in accordance with the method set out in FIG. 4.

Still with reference to FIG. 1B, using the dismiss button 180, the user may dismiss or close an article that is not of interest. Dismissing an article immediately removes it from the screen and replaces it with a different recommended article, either from a ranked list of next articles to be presented or from a list of articles stored according to some operator-defined criteria, or from an article recommendation newly generated by the recommendation module 320. Using the rate button on the recommended article boxes, the user can rate any of the recommended articles. The recommendation module 320 catches this rating and will refresh one or more recommended items, based on the new information. The user can also choose whether to receive recommendation in the “current category” (defined as the category to which the article page belongs), or across all categories or a set of categories. This interaction is achieved through the use of a category switch 130, which again may refresh the list of recommended articles. Finally, the user can launch the full-screen article widget 200 (described in further detail, below) from the article widget user interface 100 using a launch full-screen button 135, shown in FIG. 1A. This opens the full-screen article widget 200 on top of the article page, for example.

Moreover, with reference to FIG. 1A, the list of articles which are initially presented in the article boxes 110 need not be generated by the recommendation module 320.

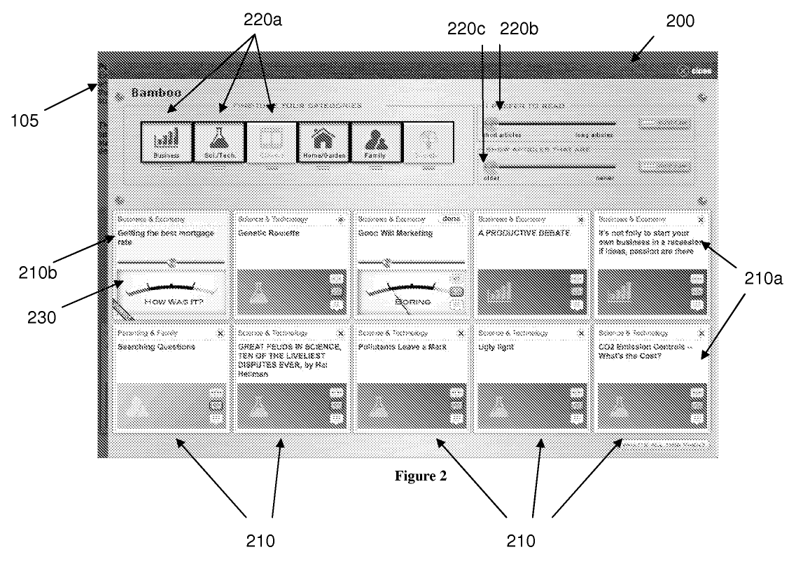

Turning now to FIG. 2, an exemplary screenshot of a full-screen widget user interface 200, according to an aspect of the present invention, is illustrated. This full-screen widget user interface 200 is opened when a user clicks on the launch full-screen button 135 from the article widget user interface 100, or by triggering it via other buttons on other pages. Preferably, the full-screen widget user interface 200 offers the following main functionalities: a list of recommended articles shown in article boxes 210, and a set of controls 220 (explained in detail below) to filter or fine-tune the recommended articles. In a preferred embodiment the list of recommended articles contains information about each such article comprising: the title of the article, and a photo or icons, from or related to the article. In a further embodiment of the present invention the information about each article contains information, such as a depiction of a traditional masthead associated with the publication where the article has been published.

Still with reference to FIG. 2, the full-screen widget user interface 200 has similar functionality to the article widget user interface 100. The user can dismiss an article box 210b, or refresh the list of recommended articles by using the set of controls 220 or by rating articles that have been read using the rating slider and meter 230, or by rating any of the recommended articles using the rate button which brings up the rating slider for that article.

Moreover, with reference to FIG. 2, the article boxes 210 are displayed according to two displays: article boxes 210a or read article boxes 210b. An article box 210 is similar to the article box 110, explained above. A read article box 210b displays an article that a user has viewed, but has not yet rated. In a read article box 210b, an article image is replaced by a rating slider and meter 230. The user can rate the article with the rating slider and meter 230. This rating will affect the list of recommended articles represented by the article boxes 210 and will refresh the list in real-time. When finished rating, the user can close that article box by clicking on the “done” button appearing on the read article box 210b. As noted, the full-screen widget user interface 200 offers a set of controls 220 to the user to filter the recommendations comprising:
(a) category filter 220a: the user can select one or multiple categories such as “Business”, “Science/Technology”, “Cinema”, “Home/Garden”, “Family”, and “Society”. If the user selects one or more categories, then only recommended articles from the selected categories are displayed;
(b) word-count filter 220b: the user can filter the recommended articles by the count of words, using a slider;
(c) date filter 220c: the user can filter the recommended articles by the date of the article, using a slider;
(d) tag filter (not shown): the user can filter the recommended articles by selecting one or multiple user-generated tags, such as from a stylized visual depiction or list of tags (e.g. tag cloud);
(e) other filters (not shown) which could control such features or aspects of content such as the number of images or graphics in the article, the duration of video or audio clips, number of slides in a slide presentation, and the like.

An embodiment of the invention provides a system which is the combination of real-time recommendation with a user interface (implemented for example in AJAX or Flash), with the user interface being adjustable by the user through the manipulation of on-line controls. An important aspect of one embodiment of the present invention is that the user's actions through the user interface may be reflected in refreshing the articles recommended to the user.

The set of controls 220 may also comprise the following additional controls (not shown) and many of these elements are also suitable for the article widget user interface 100:
(a) category navigator: using a category navigator widget, the user can navigate a category tree to select one, or multiple categories. Only the recommended articles in the selected categories would be displayed;
(b) search bar: the user can input keywords to search articles from the database. Only the article hits arising from the search would be displayed;
(c) tag editor: the user can type in or otherwise generate a tag for an article;
(d) shuffle button: the user can “shuffle” or refresh the list of recommendations;
(e) email: the user can email or share an article directly;
(f) pictures or graphics: the user can view representations of pictures and headlines in preview boxes in a recommendation system for newspapers and magazines (the pictures can be story photos or graphics, or can be standardized icon-graphics where an article has no story photos or graphics); and,
(g) video, audio or flash media: the user can view video or listen to audio right from the full-screen widget. An article containing a video is, in one embodiment of the invention, marked by a video icon. Clicking on that article's thumbnail will open an overlay screen which has the video embedded in it. The overlay screen has further controls permitting the user to view the video or close the overlay screen. In a further embodiment, the interface contains a media filter (not shown) that permits the user to specify which type or types of media (e.g. video, text along, and similar media filters), which will be the articles the user is presented with.

In accordance with the present invention, certain of these controls 220 may not be appropriate when used with non-text articles. For example, when operating upon or with a non-text article, the method and system of the present invention may, in one embodiment, omit one or more of the following:
(a) filters considering word count of articles, although for audio or video clips, duration of the clip may be used as a replacement
(b) keyword approaches in recommender module 320, since video clips may not have any keywords which can be parsed from them.

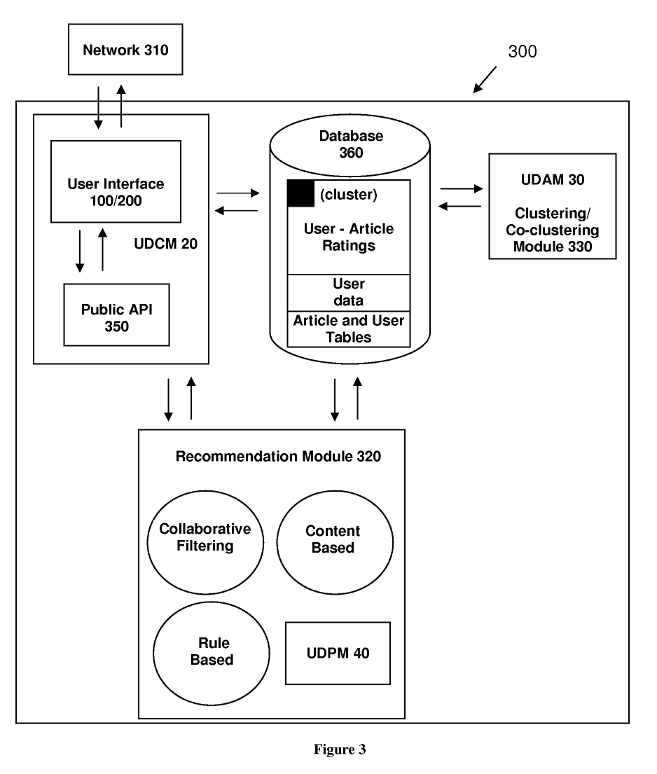

With reference now to FIG. 3, the article widget user interface 100 or full-screen widget user interface 200 (collectively, the user interface 100/200) is preferably embedded in a web page of a third party publisher website, such as a newspaper or magazine website. The user access the user interface 100/200 from a network 310, such as, for example, the Internet or an intranet. The user interface 100/200 preferably makes a request over a web service protocol (e.g. http over JSON) to a public API interface module 350, which is part of the UDCM 20, discussed below. The purpose of the public API interface module 350 is to mediate between the user interface 100/200 and the recommendation module 320. The public API interface module 350 receives requests, and control or filter information from the user interface 100/200, by querying the database 360 if necessary, and converting this filter or control information in a format that can be used by the Recommender Module 300. The filter or control information may also be stored in a separate database and retrieved when the user accesses the system.

In a preferred embodiment, when a user rates an article by interacting with the user interface 100/200, two requests (or messages) may be sent to the public API interface 350: the first, to add or update that user's rating of that (current) article to the database 360; the second, to request a list of recommended articles, along with optional parameters, discussed below.

With regard to the first request, the public API interface module 350 will store or update the rating in the database 360, and this may trigger certain stored procedures in the database 360 or in the memory of a computer handling this function. These stored procedures may include, for example, preparing the database 360 for recommendation requests, such as by calculating Slope One item deviation values or Co-Visitation item correlation values to improve the performance of the Slope One and Co-Visitation algorithms, discussed below.

With regard to the second request, the public API interface module 350 may query the database 360 using the optional parameters, and then generate a candidate item list (a set of articles from which to make recommendations), and send the candidate item list to the recommendation module 320. The recommendation module 320 will generate a recommendation result selected from the candidate item list, and this recommendation result will be passed to the public API interface module 350, and in turn, to the user interface 100/200. The public API interface module 350 may accept optional predefined parameters such as maximum returned number of items, or a candidate item list. Alternatively, the user interface 100/200 may just send a unique identifier for a user to the public API interface module 350, and request a list of recommended items, without any optional parameters.

With regard to both first and second requests noted above, the unique identifier for a user must preferably accompany the request to the public API interface module 350. Moreover, the first request is optional and need not occur for the second request, that is, a request for a list of recommended articles, to be made or fulfilled, such as, for example, when the user launches the full-screen article widget user interface 200 (i.e. not providing a rating).

An embodiment of the present invention provides a method of recommending articles to a user, as is further illustrated in FIG. 4. The steps of the method are as follows:
(a) providing the user with a list of articles to be rated or considered by displaying the initial list on a computer display device (step 410);
(b) receiving input from the user by receiving or monitoring input from at least one input device (step 420), indicating user's interaction with at least one member of said provided list of articles, said input including at least one of:
   (i) a rating for the article;
   (ii) an indication the user has viewed a preview of the article;
   (iii) an indication that the user has viewed the article;
   (iv) an indication that the user has dismissed the article; and,
   (v) an indication that the user has printed the article or emailed it;
(c) providing the input from the user to a recommendation module 320 (step 430);
(d) generating in a microprocessor at least one new recommended article, based on the input from the user (step 440); and,
(e) refreshing the list articles provided to the user to the be rated or considered, by adding information about the said at least one new recommended article to the list of articles provided user by displaying the refreshed list on the computer display device (step 450).

A further embodiment of the present invention has the further following steps:
(a) storing in a database a ranked list of next articles to be provided to the user (step 460, not shown); and,
(b) refreshing the list of articles with information about the top-ranked next article to the user when an article on the originally presented list has been dismissed (step 470, not shown).

All the listed types of input information need not be received. Further, combinations of these types of data are received in a preferred embodiment and used to generate one or more recommended articles. For example, a user may provide an explicit rating, and nothing more. Or, a user may provide an explicit rating for an article, together with a category filter (i.e. the fact that the user has accessed the article by use of the filter). Alternatively, a user may provide no explicit rating, but provide an implicit rating based on the fact of reading or previewing an article, for example. In each of these cases, the rating (implicit or explicit), together with the filter or control information, is used by aspects of the computer system 300 including the recommendation module 300 and the database 360, to generate one or more recommended articles.

A further embodiment of the present invention has the further following steps (in addition to those set out in paragraph 54**):
(a) storing in a database a list of articles (step 480, not shown); and,
(b) refreshing the list of articles presented to a user with information of one article from the list of stored articles (step 482, not shown).

addition to those set out in steps 410-450, above):
(a) labelling articles as belonging to one or more groups (step 480, not shown);
(b) receiving input from the user by receiving or monitoring input from input devices, regarding the group of articles desired to be seen by the user (step 482, not shown); and,
(c) providing the user with a list of articles (or updates to the list) selected only from articles labelled as belonging to the desired group (step 494, not shown) by displaying the initial list on a computer display device.

The group could include:
(a) the category of article (as selected by category filter 220a, shown in FIG. 2);
(b) the word-count of the article (as selected by word-count filter 220b, shown in FIG. 2);
(c) the article date, as selected by date filter 220, shown in FIG. 2);
(d) Other features or aspects of content of group members such as the number of images or graphics in the article, the duration of video or audio clips, number of slides in a powerpoint, and the like (not shown);
(e) Author of the article (not shown);
(f) Source of the article (not shown).

The system and method of an aspect of the present invention further comprises a computer system 300, as shown in FIG. 3. Computer system 300 comprises a User Data Collecting Module (UDCM) 20. The UDCM 20 collects user data from user interactions with the user interface 100/200, respectively, and stores them into a database 360, via a public API interface module 350, as discussed above. User data include static data (e.g. IP address, Internet service provider, platforms (e.g., operating systems, browsers, etc.), the time they access the system) and dynamic data (essentially behavior data, which are collected through the user interface, the most important of which are keyboard inputs and mouse clicks; also, the time that the user spent in each article, and the text appears in each clicked link). The static data are collected for further analysis. The dynamic data are collected from, for example, the search bar and the tag editor respectively. Alternatively, the system may be configured such that some user data (e.g. a selected user has read certain pages) is loaded or provided directly from third parties such as newspapers or magazine providers.

Computer system 300 further comprises a User Data Analysis Module (UDAM) 30. The UDAM 30 performs pattern analysis based on user data. For example, it can perform probability analysis to guess the user's gender, age, and profession. For example, a user who has looked at more than two football articles could be predicted to be male, according to a rule-based algorithm. UDAM 30 may also perform user clustering, article clustering, or user-article co-clustering, as is described in more detail below.

The precise functions performed in the modules and components of computer system 300 may, as will be appreciated by those of skill in the art, be performed by other modules within computer system 300 and still be within the scope of the present invention.

Computer system 300 further comprises a User Data Preprocess Module (UDPM) 40. THE UDPM 40 operates on user data to generate implicit rating data based on a set of conversion rules. In a preferred embodiment, the UDPM 40 may be part of the Recommender Module 300. In an embodiment of the present invention, user data is stored in database 360, in association with a unique identifier of the user. User data used to generate an implicit rating include:
(a) Click-through data: e.g. a user clicking on an article would generate an implicit rating that the user found something positive about the article, however, in a preferred embodiment such a rating is neither the best, nor worst, rating that can be selected.
(b) Preview data: e.g. a user reviewing an article preview would generate an implicit rating, however, it would be of typically worse quality than a click-through.
(c) User browse time: e.g. the duration of time that a user spends reading an article would generate an implicit rating, however, the data collected may be unreliable. In a preferred embodiment, reading time is used in a negative sense, i.e., if reading time is short such as, for example, less than 5 seconds, then a lower implicit rating is assigned- the second worst (lowest) rating. User reading time may require receiving the data of the online magazine or newspaper.
(d) An indication of whether the user has emailed or shared the article, or appended tags to it.

Data regarding the user's preferences is also collected implicitly by recording click-throughs, mouse-overs, and analyzing the types of recommended articles (shown in FIG. 2) the user clicks on most, looking for patterns such as:
(a) Source (e.g. name of publication from where the article was sourced);
(b) Associated media (e.g. does the article contain photographs or other graphic images? does the article contain video? does the article contain podcasts or audio streams? does the article have a PDF version available for download?);
(c) Author; and
(d) Patterns from other data, such as are comments allowed?; is the article available in “printer-friendly” format?.

With reference to FIG. 3, the UDAM 30 may comprise a Clustering/Co-clustering module 330.

Explicit rating data collected via the user interface 100/200 is stored in the User-Article Ratings table in database 360. The UDPM 40 generates implicit ratings as described in the previous paragraphs, and these implicit ratings are also stored in User-Article Ratings table in database 360. User-Article Ratings table in database 360 provides a ratings matrix according to the following chart:

| | Article₁ | Article₂ | Article₃ | . . . Article_{N} |
|---|---|---|---|---|
| User₁ | Rating = 3 | Rating = 1 | | |
| User₂ | Rating = 5 | Rating = 2 | | |
| User₃ | | | | |
| . . . | | | | |
| User_{N} | | | | |

(The blank cells in the chart may or may not have implicit or explicit ratings stored within them, provided that at least some of the cells of the table have ratings stored in them).

For user or article clustering (i.e. determining an initial evaluation amongst users or articles, the most similar users or articles may be clustered together by clustering module of UDAM 30. To facilitate clustering (i.e. to determine similarity), in a preferred embodiment the k-means algorithm is employed. The steps of the algorithm are as follows (for the example of clustering users together):
(a) For each user, a vector is formed comprising the users' rating for each article. For example, for User1 in the previous paragraph, the vector could be (3,1, . . . ). Where User1 has not rated an item the item will be deemed to be zero, a mean value of rated items or a fixed value such as three, and in a preferred embodiment is deemed to be zero.
(b) The vector space formed by these user vectors is arbitrarily divided into K partitions. Where the value of K is input by a human operator;
(c) For each partition a centroid (of the vector end-points) is calculated.
(d) Each vector is then associated with its closest centroid to form clusters;
(e) New partitions are formed, each new partition comprising the centroids and the vector end-points closest to these partitions;
(f) Steps (c)-(e) are repeated until either end-points no longer switch clusters, or the centroids do not change (or the number of end-points switching clusters or the amount of change in the centroids is below an operator specified threshold.) [Note to draft: Is the text inside the brackets correct?]
(g) The final clusters are stored.

Other algorithms can also be used to carrying out clustering, including:
(a) Distance and Similarity Measures;
(b) Hierarchical:
   (i) Agglomerative: Single linkage, complete linkage, group average method, balanced iterative reducing and clustering using hierarchies (BIRCH), clustering using representatives (CURE), robust clustering using links (ROCK);
   i) Divisive: divisive analysis (DIANA), monothetic analysis (MONA);
(c) Squared Error-Based (Vector Quantization): K means, iterative self-organizing data analysis technique (ISODATA), genetic K-means algorithm (GKA), partitioning around medoids (PAM);
(d) pdf Estimation via Mixture Densities: Gaussian mixture density decomposition (GMDD), AutoClass;
(e) Graph Theory-Based: Chameleon, Delaunay triangulation graph (DTG), highly connected subgraphs (HCS), clustering identification via connectivity kernels, (CLICK), cluster affinity search technique (CAST);
(f) Combinatorial Search Techniques-Based: Genetically guided algorithm (GGA), TS clustering, SA clustering;
(g) Fuzzy: Fuzzy c-means (FCM), mountain method (MM), possibilistic c-means clustering algorithm (PCM), fuzzy c-shells (FCS);
(h) Neural Networks-Based: Learning vector quantization (LVQ), self-organizing feature map (SOFM), ART, simplified ART (SART), hyperellipsoidal clustering network (HED), self-splitting competitive learning network (SPLL);
(i) Kernel-Based: Kernel K-means, support vector clustering (SVC);
(j) Sequential Data:
   Sequence Similarity
   Indirect Clustering
   Statistical Sequence clustering
(k) Large-Scale Data Sets: CLARA, CURE, CLARANS, BIRCH, DBSCAN, DENCLUE, WaveCluster, FC, ART;
(l) Data visualization and High-dimensional Data: PCA, ICA, Projection pursuit, Isomap, LLE, CLIQUE, OptiGrid, ORCLUS;
(m) How Many Clusters?

There are numerous benefits to clustering including:
(a) it improves performance, since the resultant “clustered” matrix has smaller dimensions; and,
(b) it groups similar users or articles together which reduces noise—and finding similarity of some kind is the key concept behind the recommender system.

More sophisticated algorithms can be used to carry out co-clustering. In co-clustering, articles and users are clustered to create article-user clustered niches. In a preferred embodiment, the algorithm used is a co-clustering algorithm, licensed by the National Research Council of Canada. The steps of the algorithm are as follows:
(a) Given the number of row clusters k and number of column clusters l, and the initial rating matrix, we normalized the rating matrix, the resulting matrix is actually a non-negative contingency table, which can be regarded as a joint distribution p(x, y), where X and Y and two discrete random variables that take values over the rows and columns.
We define coclustering as a pair of maps from rows to row-clusters and from columns to column-clusters, that is, coclustering is a pair of maps (C_{X}, C_{Y}), where

C_{X}: {x1, x2, . . . , xm}→{\hat{x}₁, \hat{x}₂, . . . , \hat{x}ₖ}

C_{Y}: {y1, y2, . . . , yn}→{ŷ₁, ŷ₂, . . . , ŷₗ}
The above notations of coclustering can be simplified as follows:

\hat{X}=Cx(X)

Ŷ=C_{Y}(Y)
Where \hat{X} and Ŷ and the two random variables induced by coclustering.
Information theory can be used to give a theoretical formulation to the coclustering problem: the optimal co-clustering is one that minimizes the loss in mutual information between the original random variables and the mutual information between the clustered random variables. Given any coclustering, we define a joint distribution

q(x,y,\hat{x},ŷ)=p(\hat{x},ŷ)p(x|\hat{x})p(y|ŷ), where xε\hat{x}, yεŷ
We can prove that the optimal co-clustering is one that minimizes the Kullback-Leibler (KL) divergence.
(b) initialization:

t=0,
randomly partition the rating matrix into k row clusters and l column clusters, We denote map functions as: Cx⁽⁰⁾ (X) and C_{Y}⁽⁰⁾ (Y)
(c) in step t+1
For each row x=(x1, x2, . . . , xn), we try to move row x into other k−1 row clusters respectively. In each iteration of such moving, we get a new row clustering, so we can compute q(x,y,\hat{x},ŷ), and then calculate the KL divergence of p(x, y) to q(x,y,\hat{x},ŷ). We select the row clustering that has the minimal KL divergence of p(x, y) to q(x,y,\hat{x},ŷ).
Thus, we get new row clustering Cx^{(t+1)} (X)
Let C_{Y}^{(t+1)}(Y)=C_{Y}^{(t)} (Y), which means we only perform row clustering in this step.
(d) in step t+2
For each row y=(y1, y2, . . . , ym), we try to move column y into other 1-1 column clusters respectively. In each iteration of such moving, we get a new column clustering, so we can compute q(x,y,\hat{x},ŷ), and then calculate the KL divergence of p(x, y) to q(x,y,\hat{x},ŷ). We select the column clustering that has the minimal KL divergence of p(x, y) to q(x,y,\hat{x},ŷ).
Thus, we get new column clustering C_{Y}^{(t+2)}(Y)
Let C_{Y}^{(t+2)}(Y)=C_{Y}^{(t+1)}(Y), which means we only perform column clustering in this step.
(e) We stop the above procedure if the change in the KL divergence of p(x, y) to q(x,y,\hat{x},ŷ) is smaller than a predefined threshold (say 0.001)

After clustering, the output is a series of groups clustering together articles or users which is stored in database 360, e.g.

| | | | |
|---|---|---|---|
| Group 1 | User1 | User3 | User7 |
| Group 2 | User2 | User4 | |
| Group 2 | User5 | | User6 |

(and similarly for articles clustering). For co-clustering, the groups contain both users and articles, e.g.

| | | | | | |
|---|---|---|---|---|---|
| Group 1 | User1 | User3 | Article3 | Article7 | |
| Group 2 | User2 | User3 | Article1 | Article3 | Article7 |

A group could include one or more articles that a specific user (and member of that group) had not rated. Co-clustering can be used, itself (without further steps of the recommender algorithm, to generate recommendations). For example, within a co-clustered group, articles rated above a threshold are recommended to a user in the group, where user has not rated the article.

Clustering or co-clustering is optional. In a preferred embodiment, clustering and co-clustering is run in the background since it is very processor-intensive. Clustering or co-clustering works best when a large numbers of users, articles and ratings are available.

The clustered results may be used as input to recommendation module 320 according to MWinnow, Slope or Co-Visitation algorithms, which algorithms operate on a clustered or co-clustered group. This improves reliability and speed of processing.

Referring to FIG. 4, step 440, in an embodiment of the invention, recommendation module 320 generates at least one new recommended Article based on input from the user. The recommendation module 320 employs one or more of rule-based, content-based or collaborative filtering-based approached (for example, MWinnow, Slope One or Co-Visitation).

Moreover, the system and method of an embodiment of the present invention further comprises a recommendation module 320, preferably based on a hybrid approach which combines collaborative filtering, rule-based, and content-based techniques. The recommendation results are generated by weighting the results from each of the recommendation algorithms. Content-based and rule-based techniques are helpful to alleviate the well-known cold-start, new item, new user and sparse rating problems. Furthermore, the engine can recommend complementary articles based on rule-based techniques.

The following table indicates how different approaches may be mixed together which may be employed in recommendation module 320 in a hybrid approach:

TABLE
Hybridization Methods

| Hybridization | |
|---|---|
| Method | Description |
| Weighted | The scores (or votes) of several recommendation |
| | techniques are combined together to produce a single |
| | recommendation. |
| Switching | The system switches between recommendation |
| | techniques depending on the current situation. |
| Mixed | Recommendations from several different |
| | recommenders are presented at the same time. |
| Feature | Features from different recommendation data |
| combination | sources are thrown together into a single |
| | recommendation algorithm. |
| Cascade | One recommender refines the recommendations |
| | given by another. |
| Feature | Output from one technique is used as an input |
| augmentation | feature to another. |
| Meta-level | The model learned by one recommender is used as |
| | input to another. |

Hybridization can alleviate some of the problems associated with collaborative filtering and other recommendation techniques.

Generally, Recommender Module 300 may take input of one or more of the following data types:

TABLE
A taxonomy of input data

| Data Type | Explanation |
|---|---|
| Demographic data | name, age, gender, profession, birth date, telephone, address, |
| | hobbies, salary, education experience and so on. |
| Rating data | rating scores, such as discrete multi-levels and continuous rating; |
| | and latent comments, such as best, good, bad, worse and so on. |
| Behaviour pattern data | duration of browsing, click times, the links of webs; save, print, |
| | scroll, delete, open, close, refresh of webs; selection, edition, |
| | search, copy, paste, bookmark and even download of web |
| | content and so on. |
| Transaction data | purchasing date, purchase quantity, price, discounting and so on. |
| Production data | for movies or music, it means actor or singer, topic, release time, |
| | price, brand and so on. While for webs or documents it means |
| | content description using key words, the links to others, the |
| | viewed times, the topic and so on. |

Rule-based. The recommendation engine may further implement rule-based recommendations. Here are two examples:
(a) Example 1: if a user reads 5 articles about NFL™ football, then label user as a male. Do not recommend fashion-related articles to users labelled as males, unless they have previously viewed a fashion-related article.
(b) Example 2: if a user reads Business Week™ articles and has not viewed or accessed five Forbes™ articles recommended to them, do not recommend any further Forbes™ articles to them.

Although the above paragraph refers to recommending similar articles to a user, complementary products or services could also be recommended to the user. This may be implemented by a Rule-based approach. For example, if a user has been recommended and has read five articles from the New Yorker™ magazine, then do propose an offer to subscribe to the magazine.

Content-based. The recommender system may also make recommendations based on the content of articles. An article may be parsed to determine tags, or to determined the frequency of keywords. A list of keywords (not shown) is stored in Database 360 of FIG. 3. If keywords in two articles are similar, then they are determined to be similar articles. In a preferred embodiment, a machine learning or statistical approach is used to create a model suggesting that the keywords of one article, for example, Article 1 are similar to the keywords another article, Article 5.

In a preferred embodiment, the collaborative filtering “CF” approaches, as described in more detail below, such as MWinnow, Co-Visitation or Slope, are also used to recommend an article, and may be used in combination with a content-based approach. For example: after a user has given a good rating (either explicitly or implicitly) to “Article 3”, the CF approaches may determine that “Article 1” is similar to “Article 3”, and the content approach may further determine that “Article 5” is similar to “Article 1”. Articles 1 and 5 would be marked to be recommended to the user or added to a list to be recommended to the user or immediately recommended to the user.

In a preferred embodiment, articles are filtered based on factors such as word length or frequency. In an embodiment of the present invention, a system and method of the present invention may also be configured to exclude documents labelled as “non-articles” by a machine learning approach. Once a document has been labelled as a non-article, it would not be presented in response to a query given to a search engine, or would not be presented by a recommendation engine. It may be desirable to label a document as an article or non-article in accordance with the following steps:
(a) receiving a new document;
(a) applying the machine learning model to the new document to produce a label of article or non-article; and,
(b) associating the produced label with the new document.

In one aspect, recommendation module 320 of the present invention will take a weighted average vote from three recommendation approaches:
(c) Mwinnow: an advantage of using Mwinnow is that it functions well in real-time and to aggregate user preferences as the user rates more articles;
(d) Slope One: can be updated on the fly and requires relatively few user ratings, and handles multi-level rating information well; and,
(e) Co-Visitation: makes it easy to collect implicit ratings.
   Where the weighted vote exceeds a threshold, the article is recommended to the user. The weighting parameters may be fixed, and in one embodiment of the present invention are 0.6 for Co-Visitation, 0.3 for Slope One and 0.1 for MWinnow

These approaches are now described in greater detail below.

Mwinnow. The MWinnow (multi-level Winnow) scheme may directly handle multiclass classification problems by extending the Balanced Winnow scheme directly. Given K possible classes c₁, c₂, . . . , c_{K} with corresponding class labels l₁, l₂, . . . , l_{K}, we define K linear functions which correspond to the K classes respectively as follows: ƒ^{(k)}(x)=w₀^{(k)}+x^{T}w₁^{(k)}, k=1,2, . . . , K. (3.1) where instance x=(x₁, x₂, . . . , xₙ)^{T}, and weight vector w₁^{(k)}=(w₁^{(k)}, w₂^{(k)}, . . . , wₙ^{(k)})^{T}, k=1,2, . . . , K. Let weight vector

$${w}^{( k )} = ( \frac{{w}_{0}^{( k )}}{{w}_{1}^{( k )}} ) = {( {w}_{0}^{( k )} , {w}_{1}^{( k )} , {w}_{2}^{( k )} , … , {w}_{n}^{( k )} )}^{T} , k = 1 , 2 , … , K .$$

We can rewrite (3.1) as follows for simplicity:

ƒ^{(k)}(x)=(1,x^{T})w^{(k)},k=1,2, . . . , K. (3.2)

Given a new instance x, we calculate the K output values of the K linear functions ƒ⁽¹⁾(x), ƒ⁽²⁾(x), . . . , ƒ^{(K)}(x). In fact, ƒ^{(k)}(x) is a measure of the distance from x to the hyperplane (1,x^{T})w^{(k)}=0, k=1,2, . . . , K. The classifier c(x) is defined as follows: c(x)=lₖ such that

$$k = {arg max}_{l < i < K} {f}^{( i )} ( x ) \qquad ( 3.3 )$$

We introduce the promotion parameter α and the demotion parameter β such that α>1 and 0<β<1, which determine the change rate of the weights. The model is not updated if the prediction is correct. If the algorithm makes a mistake such that it misclassifies x with true label lₚ to l_{q}, then we update the weight vectors w^{(k)}=(w₀^{(k)}, w₁^{(k)}, w₂^{(k)}, . . . , wₙ^{(k)})^{T} (k=1,2, . . . , K) as follows.

wⱼ^{(q)}=β^{x}^{ⱼ}wⱼ^{(q)}, j=0,1,2, . . . , n; (1)

wⱼ^{(p)}=α^{x}^{ⱼ}wⱼ^{(p)}, j=0,1,2, . . . , n; (2)

$${w}_{j}^{( k )} = {λ ( \frac{{f}^{( q )} ( x ) - {f}^{( p )} ( x )}{{f}^{( k )} ( x ) - {f}^{( p )} ( x )} )}^{{x}_{j}} {wj}^{( k )} , \qquad ( 3 )$$

∀k such that

ƒ^{(p)}(x)<ƒ^{(k)}(x)≦ƒ^{(q)}(x), j=0,1,2, . . . , n;

w^{(k)}=(w₀^{(k)}, w₁^{(k)}, w₂^{(k)}, . . . , wₙ^{(k)})^{T} is not updated if ƒ^{(k)}(x)≦ƒ^{(p)}(x); (4)

where

$$λ ( x ) = 1 - \frac{1 - β}{1 + 0.001 ⋆ {β}^{- kx}} , ( x \geq 1 , k > 0 )$$

is a monotonously increasing penalty function with the parameter k>0. It outputs a value between β and 1.

Other more sophisticated penalty functions are also available. If K=2, this is the Balanced Winnow algorithm.

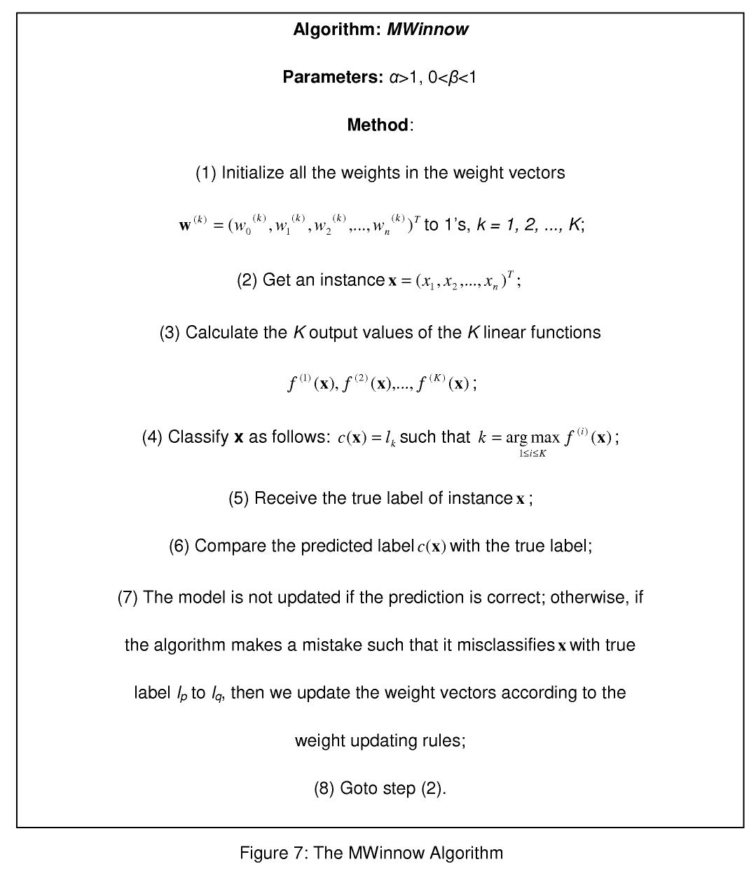

The MWinnow algorithm is summarized in FIG. 7. In geometry, this scheme is equivalent to assigning a hyperplane to each class and classifying a new instance to the class whose hyperplane is the furthest from the instance.

The theoretical and implementation computational complexity of the MWinnow algorithm is rather low. To better understand MWinnow an example is provided: Suppose a set of instances is given, the training process goes through the instance set for many passes. In each pass, every instance in the set is used to train the classifier exactly once. In the first few passes, the number of accumulated mistakes increases rapidly. The number of mistakes made by the classifier in each pass will gradually decrease because the classifier gets more and more training. If the algorithm eventually converges, the number of accumulated mistakes will increase more and more slowly until reaching a maximum value. Otherwise, the number of accumulated mistakes will increase continuously.

The MWinnow algorithm is strongly convergent on a set of instances if and only if the number of accumulated mistakes eventually stays unchanged while presenting the instances cyclically to it.

Hundreds and thousands of iterations may be required before the MWinnow algorithm strongly converges, depending on the given dataset of instances. In practice, we can remove the strong convergence condition to reduce the number of iterations. In each trial t, we compute the maximum change of the weights, i.e.,

$${max}_{l \leq k \leq K} {max}_{0 \leq i \leq n} \vert {w}_{i , t}^{( k )} - {w}_{i , t - 1}^{( k )} \vert .$$

We can define the weak converge condition as follows.

The MWinnow algorithm is weakly convergent on a set of instances if and only if the maximum change of the weights is less than a small value ε>0 while presenting the instances cyclically to it.

The mistake bound of the MWinnow algorithm is an upper bound of the maximum number of accumulated mistakes that it makes in the worst scenario before it eventually converges.

We have done some simple experiments to test its convergence using some artificial data. It has shown that the algorithm will converge if we present the noise-free training examples cyclically to it and tune α and β close to 1. In one of our experiments, we generated training data using a model with three relevant attributes and two irrelevant attributes. There were four class labels, encoded consecutively from one to four. The NMAE (Normalized Mean Absolute Error) value was 0.069 when MWinnow converged. In another experiment, training data were generated from a model with six relevant attributes and four irrelevant attributes. There were seven class labels, encoded consecutively from one to seven. The NMAE value was 0.007 when the algorithm converged. When we changed the order of training examples randomly, the NMAE values did not change significantly.

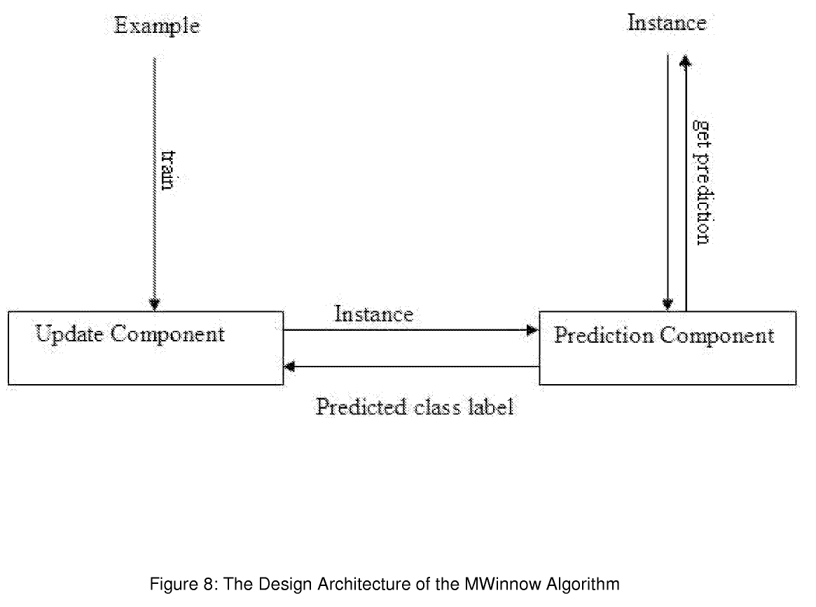

Online learning schemes are very easy to implement. FIG. 8 illustrates the design architecture of the MWinnow scheme. It consists of two main components: a component used to make predictions and a component used to update the model.

Given an instance as the input, the update component will output a predicted class label. We need to train the learner after we get the true label. An instance and its true label form an example. Given an example, the update module will calculate the predicted label by invoking methods in the prediction component. If the predicted label is different from the true label, the component will update the weight vectors.

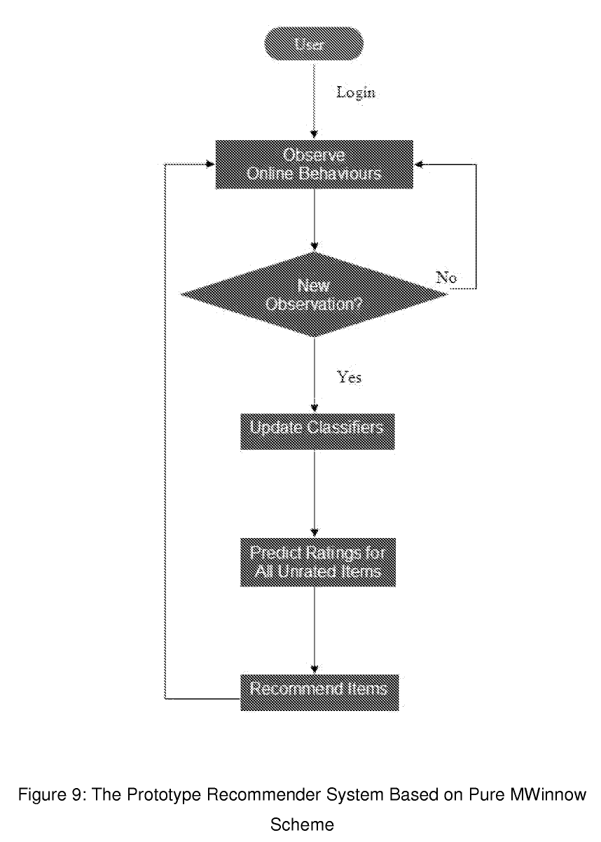

In an online recommender system, the data given are a matrix of user-article ratings. Two approaches are proposed to apply the MWinnow scheme to a model-based recommender system: pure MWinnow approach and hybrid approach. The prototype recommender system based on the pure MWinnow scheme is demonstrated in FIG. 9.

Where MWinnow is used alone (i.e. Mwinnow is given a weighting of 1.0), we train in advance an MWinnow classifier for each article by treating this article as the class attribute and all other articles as the input attributes. When the online behaviours (i.e., article ratings) of a new user are observed, his/her rating for any unrated article can be predicted using the corresponding classifier, and the articles with the highest ratings will be recommended to him/her. The observed behavior data are used to train the classifiers.

Here is a simplified example of the use of MWinnow in accordance with an embodiment of the present invention. In the example, Users 1-3 have given items 1-3 the following rating:

| User | Item₁ | Item₂ | Item₃ |
|---|---|---|---|
| User₁ | 1 | 2 | 3 |
| User₂ | 4 | 5 | 1 |
| User₃ | 2 | 3 | 4 |

(Predicted Rating)=W₀+W₁X₁+W₂X₂

Each item is associated with a MWinnow classifier. For example, MWinnow classifier c₂(\vec{x})=w₀+w₁x₁+w₂x₂ is associated with item 2. The weighting factors W₀, W₁, W₂ are initially set to one. Then further instances of ratings are used to update the weighting factors. The first instance of item ratings is used to test the initial weighting factors to see if the predicted value is equal to the true value. Taking the example of the initial predicted value for user1 item 2,

Predicted value=1+1*1+1*3=5

This is not the same as the true value which is 2, so the weighting factors are updated, as is described above. The MWinnow classifier c₂(\vec{x})=w₀+w₁x₁+w₂x₂ was trained using all the instances of item ratings in the given rating matrix.

Thus, if predictions are being created for item₂, the MWinnow classifier c₂(\vec{x})=w₀+w₁x₁+w₂x₂ can output a predicted rating value. If a new user, User₄, enters the system and provides ratings (implicitly or explicitly) for Items 1 and 3, a prediction for the rating of Item₂ for User₄ can be generated as follows:

Predicted Rating for Item₂ by User₄=W₀+W₁*(User₄ Rating for Item1+W₂(User₄ Rating for Item₃)

This predicting rating can then be used to determine if Item₂ should be recommended to User₄. For example, if the predicted rating exceeds a threshold Item₂ will be recommended to User₄.

Slope One. The slope one schemes take into account both information from other users who rated the same article and from the other articles rated by the same user. However, Slope One also relies on data points that fall neither in the user array nor in the article array (e.g. user A's rating of article 1), but are nevertheless important information for rating prediction. Much of the strength of the approach comes from data that is not factored in. Specifically, only those ratings by users who have rated some common article with the predictee user and only those ratings of articles that the predictee user has also rated enter into the prediction of ratings under slope one schemes.

Formally, given two evaluation arrays vi and wi with I=1, . . . , n, we search for the best predictor of the form fx=x+b to predict w from v by minimizing Σ1(v1+b−wi)2.

Deriving with respect to b and setting the derivative to zero, we get

$$\frac{{\sum }_{i} {W}_{i} - {V}_{i}}{n} .$$

In other words, the constant b must be chosen to be the average difference between the two arrays. This result motivates the following scheme.

Given a training set χ and any two articles j and I with ratings uj and ui respectively in some user evaluation u (annotated as u [symbol] Sj,I (χ)), we consider the average deviation of article 1 with respect to article j as:

$${dev}_{j , i} = {\sum }_{{u}_{∈} {S}_{j , {i}_{( χ )}}} \frac{j - i}{card ( {S}_{j , i} ( χ )}$$

Note that any user evaluation u not containing both uj and ui is not included in the summation. The symmetric matrix defined by devj,i can be computed once and updated quickly when new data is entered.

Given that devj,I+ui is a prediction for uj give ui, a reasonable predictor might be the average of )all such predictions.

$$P ( u ) j = \frac{1}{card ( {R}_{j} )} {\sum }_{{i}_{∈}} {R}_{j} ( devj , i . = ui )$$

where Rj={i\i [symbol] S(U), i≠j, card (Sj,I (χ))>0} is the set of all relevant articles. There is an approximations that can simplify the calculation of this prediction for a dense enough data set where almost all pairs of articles have ratings, that is, where card (Sj,i (χ))>0 for almost all I, j, most of the time Rj=S(u). Since

$$\overline{u} + \frac{1}{card ( {R}_{j} )} {\sum }_{{i}_{∈}} {R}_{j} devj , i .$$

An implementation of Slope One does not depend on how the user rated individual articles, but only on the user's average rating and crucially on which articles the user has rated.

The use of Slope One in accordance with an embodiment of the present invention will be further described with reference to the following example:

### EXAMPLE

In the example, the following ratings have been provided:

| User | Item₁ | Item₂ |
|---|---|---|
| User₁ | 4 | 3 |
| User₂ | 2 | |

For User₁ the difference or deviation between Item₂ and Item₁=−1
We apply this deviation to User₂'s rating of Item₁ to predict a rating for Item₂.

$$\begin{matrix}Predicting Rating for {User}_{2} for {Item}_{2} = {User}_{2} Rating for {Item}_{1} + \\ Deviation between {Item}_{2} + \\ {Item}_{1} ratings \\ = 2 - 1 \\ = 1\end{matrix}$$

In a preferred embodiment, if the the predicted value goes outside the range the out of range value is used for calculating a weighted average and thus a determination of whether the article should be recommended to the user.

Co-Visitation. Co-visitation helps provide recommendations where a user visits or views articles but does not provide ratings. An article based technique for generating recommendations may make use of co-visitation instances, where co-visitation is defined as an event in which two articles (stories) are clicked by the same user within a certain time interval (typically set to a few hours). Imagine a graph whose nodes represent articles (news stories) and weighted edges represent the time discounted number of co-visitation instances. The edges could be directional to capture the fact that one story was clicked after the other, or not if we do not care about the order. This graph may be maintained as an adjacency list that is keyed by the article id. On article sk, the user's recent click history Cui may be retrieved and iterated over the articles in it. For all such articles sj [symbol] Cui, the adjacency lists are modified for both sj and sk to add an entry corresponding to the current click. If an entry for this pair already exists, an age discounted count is updated. Given an article s, its near neighbours are effectively the set of articles that have been covisited with it, weighted by the age discounted count of how often they were covisited. This captures the following simple intuition: “user who viewed this article also viewed the following articles”.

For a user ui, the co-visitation based recommendation score is generated for a candidate article s as follows: the user's recent click history Cu is fetched, limited to past few hours or days. For every article si in the user's click history, the entry for the pair si is looked up, s in the adjacency list for si stored in the adjacency list. To the recommendation score, the value stored in this entry normalized by the sum of all entries of si is added. Finally, all the co-visitation scores are normalized to a value between 0 and 1 by linear scaling.

If the results from these algorithms are not satisfactory, then the recommender module 300 will default to one or more “most popular articles” (according to views, comments, or email or some other measure of popularity.)

The recommendation module 320 will insert a proportion of new articles randomly into the stream of articles being recommended, to encourage rankings for these new articles.

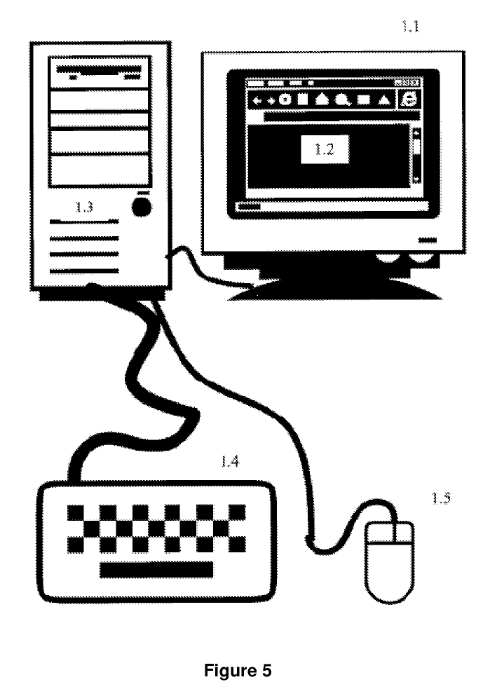

FIG. 5 shows a general computer system on which the invention might be practiced. The general computer system comprises of a display device (1.1) with a display screen (1.2). Examples of display device are Cathode Ray Tube (CRT) devices, Liquid Crystal Display (LCD) Devices etc. The general computer system can also have other additional output devices like a printer. The cabinet (1.3) houses the additional basic components of the general computer system such as the microprocessor, memory and disk drives. In a general computer system the microprocessor is any commercially available processor of which x86 processors from Intel and 680X0 series from Motorola are examples. Many other microprocessors are available. The general computer system could be a single processor system or may use two or more processors on a single system or over a network. The microprocessor for its functioning uses a volatile memory that is a random access memory such as dynamic random access memory (DRAM) or static memory (SRAM). The disk drives are the permanent storage medium used by the general computer system. This permanent storage could be a magnetic disk, a flash memory and a tape. This storage could be removable like a floppy disk or permanent such as a hard disk. Besides this the cabinet (1.3) can also house other additional components like a Compact Disc Read Only Memory (CD-ROM) drive, sound card, video card etc. The general computer system also had various input devices like a keyboard (1.4) and a mouse (1.5). The keyboard and the mouse are connected to the general computer system through wired or wireless links. The mouse (1.5) could be a two-button mouse, three-button mouse or a scroll mouse. Besides the said input devices there could be other input devices like a light pen, a track ball, etc. The microprocessor executes a program called the operating system for the basic functioning of the general computer system. The examples of operating systems are UNIX™, WINDOWS™ and OS X™. These operating systems allocate the computer system resources to various programs and help the users to interact with the system. It should be understood that the invention is not limited to any particular hardware comprising the computer system or the software running on it.

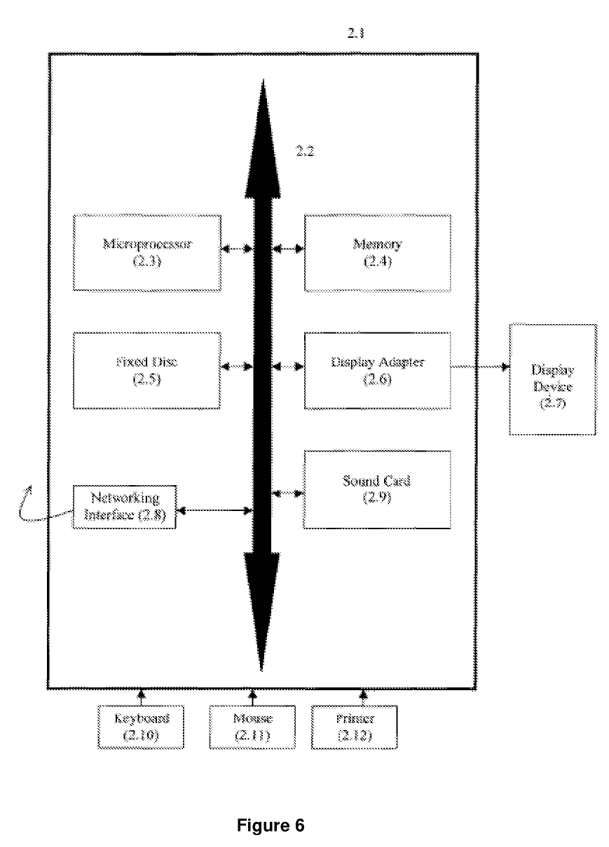

FIG. 6 shows the internal structure of the general computer system of FIG. 5. The general computer system (2.1) consists of various subsystems interconnected with the help of a system bus (2.2). The microprocessor (2.3) communicates and controls the functioning of other subsystems. Memory (2.4) helps the microprocessor in its functioning by storing instructions and data during its execution. Fixed Drive (2.5) is used to hold the data and instructions permanent in nature like the operating system and other programs. Display adapter (2.6) is used as an interface between the system bus and the display device (2.7), which is generally a monitor. The network interface (2.8) is used to connect the computer with other computers on a network through wired or wireless means. The system is connected to various input devices like keyboard (2.10) and mouse (2.11) and output devices like printer (2.12). Various configurations of these subsystems are possible. It should also be noted that a system implementing the present invention might use less or more number of the subsystems than described above. The computer screen which displays the recommendation results can also be a separate computer system than that which contains components such as database 360 and the other modules described above.

The general computer system of the foregoing paragraphs may be configured to allow the user to operate the user interface 100/200 300 of FIG. 3. This can be achieved by, for example, having the user interface 100/200 embedded in a web page accessible on a web browser (such as Internet Explorer™, Google Chrome™, Firefox™, and Safari™) running on the general computer system. Moreover, the same or another general computer system may be configured to operate the various other modules shown in FIG. 3. including one or more of the public API interface 350, the database 360 and the other modules described above.

What has been described above includes examples of the present invention. It is, of course, not possible to describe every conceivable combination of components or methodologies for purposes of describing the present invention, but one of ordinary skill in the art may recognize that may further combinations and permutations of the present invention are possible. Accordingly, the present invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A computer-implemented method of providing recommendations for articles, comprising the steps:
(a) providing a user with an initial list of articles by displaying the initial list on a computer display device;
(b) receiving input from the user by receiving or monitoring input from at least one input device, said input comprising one or more of:
(i) an explicit rating for one of said initial list of articles;
(ii) user data in relation to the user;
(iii) an indication the user has changed or set a filter;
(c) generating in a microprocessor at least one new recommended article from a list of possible articles, based on the input received from the user;
(d) refreshing the initial list of articles with said at least one new recommended article to produce a refreshed list; and,
(e) providing the user with the refreshed list by displaying the refreshed list on the computer display device.

2. The computer-implemented method of claim 1, where the user data comprises one or more of:
(iv) an indication user has viewed or accessed one of said initial list of articles;
(v) an indication user has viewed or accessed a preview of one of said initial list of articles;
(vi) an indication user has printed or emailed one of said initial list of articles
(vii) an indication user has tagged an article;
(viii) an indication user has accessed a tag.

3. The computer-implemented method of claim 1, where the user data comprises an indication user has dismissed one of said initial list of recommended articles.

4. The computer-implemented method of claim 1, where at least one instance of the initial list of articles or the refreshed list of articles shows the title of said instance and an image or icon associated with said instance.

5. The computer-implemented method of claim 1, where the initial list of articles is a list of recommended articles.

6. The computer-implemented method of claim 1, where the user data is used to generate an implicit rating of an article, and the implicit rating is used to generate the at least one new recommended article.

7. The computer-implemented method of claim 1, where the at least one new recommended article is generated based on at least two of the following approaches: co-clustering, a rule based approach, a content based approach, Slope One, Mwinnow and Co-visitation.

8. The computer-implemented method of claim 7, where the recommended article is generated based on Mwinnow and one or more other approaches.

9. The computer-implemented method of claim 1, where the method further comprises the steps of:
(a) storing a ranked list of next articles to be provided to the user;
(b) refreshing the list with a top-ranked article, to generate a further refreshed list, when an item on the initial list or the updated list has been dismissed by the user;
(c) presenting the further refreshed list to the user.

10. The computer-implemented method of claim 1, where the method further comprises the steps of:
(a) storing a list of articles to be provided to the user;
(b) refreshing the list with an article from the stored list, to generate a further refreshed list, when an item on the initial list or the refreshed list has been dismissed by the user; and,
(c) presenting the further refreshed list to the user.

11. The computer-implemented method of claim 1, where the method further comprises the steps of:
(a) labelling each instance of the possible list of articles as belonging to one or more groups;
(b) receiving input from the user indicating one or more desired groups;
(c) selecting the initial list of articles and the at least one new recommended article from instances of the list of possible articles which are a member of the one or more desired groups.

12. The computer-implemented method of claim 11, where the one or more groups include one or more of: categories of articles, word length of articles, date of articles, number of images in the article, source of the article or author of the article.

13. A computer-implemented method of recommending articles, comprising the steps of:
(a) storing a set of possible articles in a database;
(b) receiving information from, or relation to, a first user, by receiving or monitoring input from at least one input device, said information including at least one of:
(i) demographic data about the first user;
(ii) rating data about one of the set of possible articles from the first user;
(iii) user data in relation to the first user;
(iv) transaction data in relation to the first user
(v) information relating to content of an article of interest to the first user.
(c) determining in a microprocessor a similarity between the received information and at least one of:
(i) demographic data about a second user;
(ii) rating data about one of the set of possible articles from the second user;
(iii) user data in relation to the second user;
(iv) transaction data in relation to the second user
(v) information relating to content of an article of interest to the second user.
(d) recommending to the first user information about a second article from the set of possible articles based on the determined similarity, by displaying the information about the second article on a computer display device, where the recommendation is generated by MWinnow.

14. The method of claim 13, where the recommendation is generated by MWinnow, and one or more of: co-clustering, Slope One, Co-Visitation, content-based approach or a rules-based approach.

15. The method of claim 14 further comprising the steps of: calculating a weighted average of results produced by MWinnow, Slope One, and Co-Visitation, and providing a recommendation when the weighted average exceeds a threshold.

16. A computer program product comprising: a memory having computer readable code embodied therein, for execution by a CPU for recommending documents, said code comprising:
(a) code means for providing a user with an initial list of articles by displaying the initial list on a computer display device;
(b) code means for receiving input from the user by receiving or monitoring input from at least one input device, said input comprising one or more of:
(i) an explicit rating for one of said initial list of articles;
(ii) user data in relation to the user;
(iii) an indication user has changed or set a filter;
(c) code means for generating in a microprocessor at least one new recommended article from a list of possible articles, based on the input received from the user;
(d) code means for refreshing the initial list of articles with said at least one new recommended article to produce a refreshed list; and,
(e) code means for providing the user with the refreshed list by displaying the refreshed list on the computer display device.

17. A computer program product comprising: a memory having computer readable code embodied therein, for execution by a CPU for recommending articles, said code comprising:
(a) code means for storing a set of possible articles in a database;
(b) code means for receiving information from, or relation to, a first user by receiving or monitoring input from at least one input device, said information including at least one of:
(i) demographic data about the first user;
(ii) rating data about one of the set of possible articles from the first user;
(iii) user data in relation to the first user;
(iv) transaction data in relation to the first user
(v) information relating to content of an article of interest to the first user.
(c) code means for determining in a microprocessor a similarity between the received information and at least one of:
(i) demographic data about a second user;
(ii) rating data about one of the set of possible articles from the second user;
(iii) user data in relation to the second user;
(iv) transaction data in relation to the second user;
(v) information relating to content of an article of interest to the second user;
(d) code means for recommending to the first user information about a second article from the set of possible articles based on the determined similarity, by displaying the information about the second article on a computer display device, where the recommendation is generated by MWinnow.

18. A computer system comprising the following elements:
(a) an interface for receiving input from a user by receiving or monitoring input from at least one input device, said input comprising one or more of:
(i) an explicit rating for one of an initial list of articles presented to the user;
(ii) user data in relation to the user;
(iii) an indication the user has changed or set a filter;
(b) a user data collection module, for collecting the input from the user and for transmitting information to the user regarding articles;
(c) a database, for storing the input, a list of possible article ratings table, and article and user table;
(d) a recommender module, for recommending to the user information about one of the list of possible documents, said recommendation based on said input.

19. The computer system claimed in claim 18, further comprising: a user data pre-processing module, which performs one or more of: generating an implicit rating for an article.

20. The computer system claimed in claim 18, further comprising a user data analysis module for carrying out one or more of the following: clustering, co-clustering, pattern analysis.
